(19) United States
(12) Patent Application Publication
(10) Pub. No.: US 2004/0072613 A1
(43) Pub. Date: Apr. 15, 2004

(54) Method and apparatus for gaming

(76) Inventor: Martin Visocnik, Indooroopilly (AU)

Correspondence Address: Anderson & Morishita, L.L.C., Suite102, 2725 S. Jones Blvd., Las Vegas, NV, 89146, US

(21) Appl. No.: 10/620,821

(22) Filed: Jul. 16, 2003

(30) Foreign Application Priority Data
Jul. 17, 2002 (AU) 2002300162

(51) Int. Cl. A63F 13/00

(52) U.S. Cl. 463/25; 463/16

(57) ABSTRACT

A gaming machine adapted to play a primary game of rotating reels, where a secondary game is offered upon a trigger condition, for which the trigger probability depends on an unpredictable event or result in the primary game other than a combination selected symbols in a game outcome. In one embodiment a consolation jackpot prize is offered in the secondary game for which the trigger probability is dependent on the loosing wager in the primary game. In further embodiments a jackpot prize is offered depending on the amount won in the primary game or alternatively on the number of winning lines, the number of loosing lines, or the winning wager in the primary game.

### FIELD OF THE INVENTION

The present invention relates to a gaming console and to a network of gaming consoles. In addition, the present invention relates to a method of gaming.

### BACKGROUND TO THE INVENTION

There are a variety of schemes that have been adopted to attract users to particular gaming machines in preference to others. For example, jackpots or secondary prizes may be employed to make a particular gaming machine more attractive to a potential player.

Gaming machines offering linked progressive jackpots are typically networked and a proportion of the turnover from each machine is added to a prize pool from which a jackpot is paid. One such progressive jackpot system pays a jackpot once the pool exceeds a preset amount. One extension of such an arrangement is commonly known as “Cashcade™”. The Cashcade™ method awards the jackpot after a predetermined value has been exceeded in the prize pool and a randomly selected number is matched. In one variation the randomly selected number is matched against a number allocated to each credit wagered. Other variations employ a randomly selected number to determine a gaming machine to which the jackpot is awarded after a randomly selected number of credits have been played. Certain other progressive jackpot systems award a jackpot when selected triggering symbol combinations are obtained during a game outcome.

All of these systems have perceived disadvantages to potential players as a whole. For example, where the jackpot system pays a jackpot once the prize pool exceeds a preset random amount, the probability of winning the jackpot increases as the prize pool grows, providing a clear disadvantage in playing while the prize pool is small. Furthermore where the games are assigned a number based on credit bet that is matched against a random number generated on the network there is no account taken of the result of the primary game or whether the player was successful or not. Similarly where a machine is selected and a prize awarded after a selected number of credits having been played, there has been no account taken of the result of the primary game where a prize may have already been awarded.

Systems where machines are awarded a jackpot when a certain game result and/or triggering combination is obtained, have the disadvantage that the triggering combinations odds must be identical for all machines on the system. This has the effect of limiting the variety of games that can be offered on the machines linked to the jackpot system.

International Patent Application No. PCT/AU98/00525 (WO 99/03078) there is described a scheme whereby the chance of winning the jackpot is proportional to the stake wagered. In the systems described above the wager or stake is used directly in a scheme that determines the trigger condition for a jackpot thus being responsible for the trigger. This direct usage applies also to a system discussed above where the trigger condition consists of the pool reaching a preset amount, and it can be said that the wager directly causes the pool to exceed the preset amount. Further the direct usage also applies to the system discussed above where the progressive jackpot is triggered by a combination of symbols in the primary game where the entire wager is staked in the game responsible for the trigger. It can be said that in all of the above-discussed systems the wager is directly responsible for determining the trigger condition of the jackpot. It can be said that such systems provide a certain degree of predictability.

We found that by using the result of the primary game (or a component of the result) in a system that determines the trigger condition of the jackpot, we provide a further degree of unpredictability and randomness. A group of potential player may perceive this as a fairer system. Alternatively instead of using an unpredictable event such as the result of the primary game and passing it to the scheme that determines the trigger condition, other unpredictable results of other games or other events may be used to provide an unpredictable result that can be passed to the scheme that determines the trigger condition.

We have further found that in a group of potential players the system described in International Patent Application No. PCT/AU98/00525 (WO 99/03078) and systems where the trigger condition can only be met once the pool reaches a preset amount, are considered unfair in that all players are awarded with a second chance irrespective of the success or failure of the player playing the primary game. We have found that by making the chance of winning the jackpot proportional to a determination of the primary game, such as the portion wagered on losing outcomes a group of potential players is attracted to this game to a significantly greater extent than to games linked to a jackpot system employing the methods described above due to increased unpredictability of the said trigger. The scheme now proposed by the inventors provides the consumer with a useful choice.

### SUMMARY OF THE INVENTION

In a first broad form, the present invention provides a gaming console comprising a display, a game controller, a stake selector, and a game initiation means wherein on initiation by the game initiation means in a primary game the game controller selects a plurality of symbols and displays the selected symbols on said display and awards a prize based upon the stakes wagered on winning combinations of the selected symbols, and wherein in a secondary game after the awarding of prizes in the primary game the game controller awards secondary prize in the event of a trigger condition wherein the probability of said trigger condition is dependant on a determination of the primary game other than a combination of symbols.

In a second broad form the present invention provides a network comprising a multiplicity of gaming consoles wherein each of said multiplicity of gaming consoles comprises a display, a game controller, a stake selector, and a game initiation means wherein on initiation by the game initiation means in a primary game the game controller selects a plurality of symbols and displays the selected symbols on said display and awards a prize based upon the stakes wagered on winning combinations of the selected symbols and wherein in a secondary game after the awarding of prizes in the primary game the game controller awards a secondary prize in the event of a trigger condition wherein the probability of said trigger condition is dependant on a determination of the primary game other than a combination of symbols.

In a third broad form, the present invention provides a method of gaming comprising the steps of:

in a primary game selecting a plurality of symbols and displaying the selected symbols on the display;

awarding a prize based upon a stake wagered on winning combinations of the selected symbols;

determining the stake wagered on losing combinations of the selected symbols; and

in a secondary game awarding a secondary prize in the event of a trigger condition wherein the probability of said trigger condition is dependant on a determination of the primary game other than a combination of symbols.

### DESCRIPTION

It will be understood in the context of the present invention that the primary game offered on the gaming console may vary from selecting a plurality of symbols and displaying the selected symbols on the display which is typical of spinning reels games, to the gaming console selecting one symbol in a roulette type game and awarding prizes for obtaining matches between the characteristics of the selected symbol and player selected fields that represent possible characteristics of selectable symbols. Further the primary game may very in that the gaming console selecting a number of symbols in a lottery or keno type game and awarding prizes for obtaining matches between player marked fields representing symbols and gaming console selected symbols. Both of these alternative types of games are well known in the art.

The present invention provides a secondary prize or jackpot based upon a trigger condition which has a probability dependant on a determination of the primary game other than a combination of symbols. It will be understood that in the context of the present invention the probability of the trigger condition may be directly proportional to the stake wagered on losing combinations, for which no prizes are awarded, or may be inversely proportional to the stake wagered on losing combinations, for which no prizes are awarded. Thus, in one embodiment of the present invention, where a losing wager is responsible for the triggering of a Jackpot, the playing of the secondary game is similar to a second draw prize, or a consolation prize. The selected portion may alternatively be the stake wagered on winning combinations, for which prizes are awarded. In this alternative embodiment where the trigger condition probability is proportional to the stake wagered on the winning combinations for which prizes are awarded, the secondary game may be considered as a bonus or ancillary prize associated with selecting winning combinations in the primary game.

In a further embodiment of the present invention the said trigger condition probability may be directly proportional to the prizes awarded in the primary game, thus in this context the secondary game may be considered as connected to the more that is won in the primary game the higher the probability of winning in the secondary game.

Whilst it will be appreciated that one embodiment of the present invention provides a trigger condition probability that is dependant on an outcome of the primary game such as a selected portion of the stake wagered in the primary game, that the game outcome proved to be a loosing wager, for which no prizes are awarded, and a second embodiment provides a trigger condition probability that is proportional to the amount won in the primary game, for convenience the present invention will be described with reference to a trigger condition that is directly proportional to the stake wagered on losing combinations for which no prizes are awarded. It will be appreciated that the present invention contemplates a trigger condition probability that is inversely proportional to the stake wagered on losing combinations. It will be further appreciated, that the triggering condition resulting in the awarding of a jackpot or secondary prize, may also be activated in a multi layered scheme where the scheme consists of a number of steps and determinations before the trigger condition is achieved. For example the trigger condition for a jackpot may be achieved when a chain of sub-trigger conditions are all satisfied. These sub-triggers may be satisfied all within the same game play or in a sequence of game plays. For example, one such scheme may be where the player obtains a win for a wager in a first primary game, this win may then be used to determine a first sub-trigger. A second primary game immediately following the first primary game may produce a losing combination for a wager and subsequently trigger a second sub-trigger and if both sub-triggers were satisfied a jackpot would be triggered. It will be further appreciate that the probability of achieving the trigger condition rather than being limited to depend on losing bets, winning bets or amount won or lost, may depend on any amount that contains at least some component of randomness other than a displayed combination of symbols by itself, for example the probability of achieving the trigger condition may depend on the combination of a random number and the amount wagered in the primary game that resulted in no prize. Thus any method that produces a variable and unpredictable outcome may be used in entering the scheme that can achieving the trigger condition and therefore the probability of obtaining the trigger condition would not be a function of the amount wagered but would vary randomly between game plays, providing the player with a further element of randomness.

The gaming console includes a display. The display may be preferably a video screen on which symbols selected by the game controller are displayed but any other suitable display media may also be used for this purpose, including TFT, LCD or projection displays, hereafter for convenience referred as video. Conveniently, in a video screen display, winning combinations may be identified by changing the colour of the selected symbols that have resulted in a winning combination or by causing those symbols to flash, blink, become animated, or by other means known in the art. A video display may also advantageously provide the player with information about the game, including instructions, or information about goods and services that may be available at or near the venue at which the gaming console is located. The video screen may also display information regarding the players credit or stake that is being wagered on various betting options of the game offered on the gaming console, and may display information about prizes awarded or that can be obtained.

Alternatively, the display may be a window through which the player may view an analog display of the symbols selected by the game controller. In such arrangement the additional information about the game is provided to the player on other suitable media as known in the art.

In one embodiment, the game controller may select a plurality of symbols and causes those symbols to be displayed on the display. Depending on the game offered on the game console, in another embodiment the game controller may get a signal from a network about one or more selected symbols and cause the display to display information about these selected symbols. For convenience the present invention will be described with reference to a game controller selecting a plurality of symbols and it will be appreciated that the present invention contemplates gaming consoles that obtain signals from a network about selected symbols. The game controller may be a computing device with a random, or pseudo random number generator (RNG) wherein each number or groups of numbers have a symbol associated with them, and wherein the symbol is displayed on the display upon the selection of an appropriate number by the RNG of the game controller. The game controller selects the symbols after receiving a signal from the game initiation means. The game controller may be a mechanical electrical or electronic device that causes a digital or analog system to display symbols on a display after they were randomly, or pseudo randomly selected.

The stake selector may include one or more physical or virtual buttons that may allow a player to select the amount of credits or monies to be wagered on the game provided by the game controller. The stake selector typically allows a player to place a number of separate bets on various aspects of the game provided by the game controller. For example if the game offered by the game controller is a spinning reels game where selected symbols are displayed on the display in a matrix, the player may select to enable a number of lines of the matrix by placing a wager on each enabled line or pre-selected combination of lines thereof. If the game controller selects and displays on the display symbols that form win combinations along an enabled line the game controller awards a prize for the wager on that winning line. In addition prizes may also be paid if the selected symbols form win combinations that appear scattered on the matrix. Thus, in this type of games a wager may be awarded a prize if win combinations occur on the line where the wager Was placed or if they occur scatted on the display. Typically when a win combination for scatters occurs, all wagers of the game are awarded a prize. Prizes are awarded according to a prize table and are awarded when matches between displayed symbols and combinations listed in the prize table exist. It is to be understood that the game offered by the game controller could be of a variety of types and not limited to only games where selected symbols are displayed on the display but could include a game such as roulette where one symbol is selected which may not be displayed on the display, but appear on an external device, and where wagers are placed on any of the possible game outcomes rather than on only a small set of preset win combinations such as those typically found on spinning reel games.

The game initiation means may be in the form of at least one physical or virtual buttons or other activation device that are controlled by the player. Such buttons may be integrated or combined with a stake selection. Alternatively, the game initiation means may be in the form of a timed initiation whereby the game controller selects and displays symbols periodically. In a further alternative configuration the game initiation means may be from a source external to the game console such as through a network to which the games console is connected. There may be also a number of other types of initiation means as well known in the art, and it suffices to say that initiation means exist.

The game console may include other features such as the additional displays that may provide information to the player in respect to the size of the jackpot or other advertising materials. The game console may include a coin or token receiving means whereby coins or tokens may be inserted into the machine in order to obtain credits that may be used as a stake. Note collecting means may also be provided as well as means for receiving electronic tokens such as on a read/writeable electronic card, or credits being awarded by external sources such as over a network, or other recognition devices that are designed to add monies or credits to the game console.

The game console may include also a credit or monies redemption means in the form of coin dispensers, banknote dispensers, ticket printers, electronic cards reader/writer, magnetic card reader/writer, or such credits or moneys may be transmitted via a network or via a radio or other type of signal in a form that can eventually be converted or exchanged for some sort of consideration. It suffices to say that there may be means for redemption of prizes obtained.

A gaming console may be a physical device dedicated to the purpose of gaming consol or may be a multipurpose device that may be configured to act temporarily as a gaming consol. Alternatively a gaming console may be virtually hosted on a multitasking device that can act as a gaming console such as a Personal Computer over the Internet. Gaming consoles may therefore not encompass all their components (physical or virtual) such as selection means, initiation means, RNG or others on the same device as these components may be hosted on a number of devices that are networked.

The primary game may be of any convenient type where a player in one embodiment wagers one or more bets against a certain set of coordinates of a said game matrix where game outcomes produced by the gaming console are displayed. If certain combinations of displayed symbols appear in the set of coordinates against which a bet was wagered the gaming console awards a prize for that bet to the player. The player may obtain a number of prizes if a number of sets of coordinates contain win combinations of symbols and if a bet was placed on such set of coordinates. A single bet may also be wagered against a number of sets of combinations of the matrix and therefore each bet may obtain a number of prizes. For example a bet may be placed against coordinates of the matrix that appear in a line and at the same time it may also be placed against combinations that appear scattered on the matrix. Thus each bet may be placed against a number of sets of coordinates of the matrix and the total wager in one game may include a number of distinct bets. It may be said that bets are placed concurrently on the same game outcome and are placed against different coordinates or aspects of the game. Games of this type include those that are played on slot machines or poker machines. Typically a primary game for use in the present invention may involve the selection of at least two symbols wherein prizes are paid on the basis of the number of matching symbols or on certain selected coordinates of the said game matrix wherein symbols are displayed. In more complex games the said game matrix may be divided into a number of rows and winning combinations may occur on one or more rows, on diagonals or other arrangement of coordinates of the matrix, referred in the art as lines. The player may select to wager a stake against the outcome on a selected game matrix coordinate on any of the one or more lines of selected symbols displayed.

In an alternative embodiment in the primary game the player may wager bets against characteristics of symbols that may be selected as a game outcome, and may place bets on fields (physical or virtual) representing such symbol characteristics. The game outcome produced by the game controller, or by an external device, may be displayed on the display and if the characteristics of the selected symbol or symbols match the characteristics against which a bet was wagered, the gaming console awards a prize for that bet to the player.

The prize awarded on the primary game is typically in proportion to the likelihood of the particular winning combination being selected by the game controller. The prize may be paid by dispensing coins or by adding credits to the gaming console.

At the completion of each primary game the game controller examines the game outcome to determine the value to be used to cause the trigger condition of the secondary game. The game controller may determine this value directly by considering the portion of the wager that did not produce a prize or by subtracting the stake wagered on winning outcomes from total stake wagered on the game. A secondary game, or jackpot game, is played after the primary game. The game controller awards a secondary prize in the event of a trigger condition. The trigger condition may be the unpredictable wager that resulted in a loss, matching a number in a set of random or pseudo random numbers selected by the game controller. The likelihood of the trigger condition being met varies randomly in each game and is proportional to selected portion of the stake wagered as determined by the game outcome.

In one embodiment of the present invention the selected portion is the stake wagered on losing combinations and that result in a loss may provide the player with a set of numbers so that the size of the said player's set is equal to or proportional to the losing wager. For example the said player's set may contain sequential numbers commencing from one up to the number of credits wagered on losing combinations. The game controller may select a number within a given range and where the selected number falls within the set of numbers provided in proportion to losing credits waged (the said player's set), a jackpot or secondary prize is awarded. In an alternative embodiment of the present invention the stake wagered resulting in a loss may be added to a random number selected from a given range. The resulting number may provide the player with a range of numbers that starts from zero and ends with the said resulting number. The game controller may select a number within a given range and if the selected number falls within the range of numbers provided to the player, a jackpot or secondary prize is awarded. In yet an alternative embodiment of the present invention, the stake wagered that resulted in a loss may be added to a random number selected from a given range (or the losing wager may be used on its own) and the resulting number may be used as a wager in a secondary game. The secondary game may be characterized in that the game controller may select symbols and signal a trigger condition for a jackpot or secondary prize should one or more selected symbols match a given set of win combinations. In addition the higher the wager in this secondary game, the higher the chance of obtaining a win combination. The secondary game may be displayed on the display or may be played without the player being made aware of it. Alternatively, a trigger condition for a jackpot or secondary prize may occur if (i) the combination of symbols displayed on the display means matches a combination in a given set of combinations of symbols and (ii) in addition if a random number selected in a given range also falls within a second given range. In a further embodiment of the invention, the jackpot may be awarded as a random time event to an assigned gaming machine, or to a random gaming machine where any of these may be coupled with some other random event produced by the primary game. In a yet further embodiment of the invention, the jackpot may be awarded as combination of one or more events of random nature that are not related to the primary game coupled with one or more random events that are related to the primary game, and this result being used to cause the trigger condition. For example the jackpot may be triggered by a scheme that uses as input a combination of four numbers the first being a randomly selected time event (this may be the fraction of the second expressed in milliseconds that corresponds to the time the player initiated the game, which time is uncontrollable by the player), the second being a random number, the third being the primary game resulting in a certain combination where combinations are mapped to numbers and the so selected number being used, and the fourth being the win obtained in the primary game, all these four elements being then added together and used as the said input. Thus it can be said that the trigger condition depends on at least one random event related to the result of the primary game and its coupling with other events (random or not) to any degree should be considered as variations of the invention. The size of the range from which the random number is selected to determine the trigger condition may be based upon the size of the secondary prize to be awarded or the desired likelihood of the secondary prize being awarded.

The occurrence of the said trigger condition may be notified to the player by the appearance of a jackpot character, where the jackpot character may dance in a fanciful manner on the display means before reveling the size of the secondary prize awarder by the gaming console. Alternatively the said jackpot character may prompt the player to start by interacting with the initiation means a jackpot game that may be displayed on the display. The outcome of the jackpot game, or sequence of plays of the jackpot game may be used by the game controller to determine the size of the secondary prize awarder by the gaming console.

The gaming console may include also a secondary display means where the sizes of progressive jackpots awarded to the player should the said trigger condition be satisfied, are displayed. Upon the occurrence of the trigger condition and the gaming console awarding a progressive jackpot prize, the secondary display would be controlled by the gaming controller to stop displaying the value of the progressive jackpot awarded and would be updated to display a replacement value instead. The secondary display means may be a video display of the CRT type or alternatively of TFT, LCD or plasma type or may have the image projected on a screen or some other media. The secondary display may also be of analogue type with flipping cards or of electromechanical type, as well as other types as used for this purpose and known in the art.

In a second aspect of the present invention the gaming console may be connected to a network of other gaming consoles. The network of gaming consoles may allow the performance of the consoles to be readily monitored and the amount wagered and the amount paid in winning prizes to be monitored. The elements of the gaming console described above, such as the display means, the secondary display means the gaming controller, the stake selector, the game initiation means, the credit or moneys input means and the primary game, secondary game or jackpot game, or the secondary game trigger means may be distributed over the network and may be centralized for a number of gaming consoles on a network controller or may be hosted on a network controller instead of the gaming console. The jackpot character may also be displayed on a centralized display means and may be displayed as temporarily moving from the centralized display to the display means of a gaming console in an animated sequence that notifies the player of the occurrence of the trigger condition for a secondary prize for that gaming console.

The present invention will now be described with reference to the following drawings and examples in order to illustrate the present invention. The drawings and examples are provided for illustrative purposes and are not intended to limit the scope of the invention described herein.

### BRIEF DESCRIPTION OF THE DRAWINGS

FIG. 1 is a perspective view of a gaming console according to one embodiment of the present invention;

FIG. 2 is a schematic diagram of a network according to one embodiment of the present invention;

FIG. 3 is a flow chart showing a method of gaming according to one embodiment of the present invention;

FIG. 4 is a schematic diagram of a network according to one embodiment of the present invention;

FIG. 5 is a schematic diagram of a network according to the embodiment of the present invention shown in FIG. 4;

FIG. 6 is a schematic diagram of a screen showing the operation of the method of one embodiment of the present invention on a gaming console;

FIG. 7 is a schematic diagram of a screen showing the operation of the method of one embodiment of the present invention on a gaming console;

FIG. 8 is a schematic diagram of a screen showing the operation of the method of one embodiment of the present invention on a gaming console; and

FIG. 9 is a schematic diagram of a screen showing the operation of the method of one embodiment of the present invention on a gaming console.

### DETAILED DESCRIPTION OF THE DRAWINGS

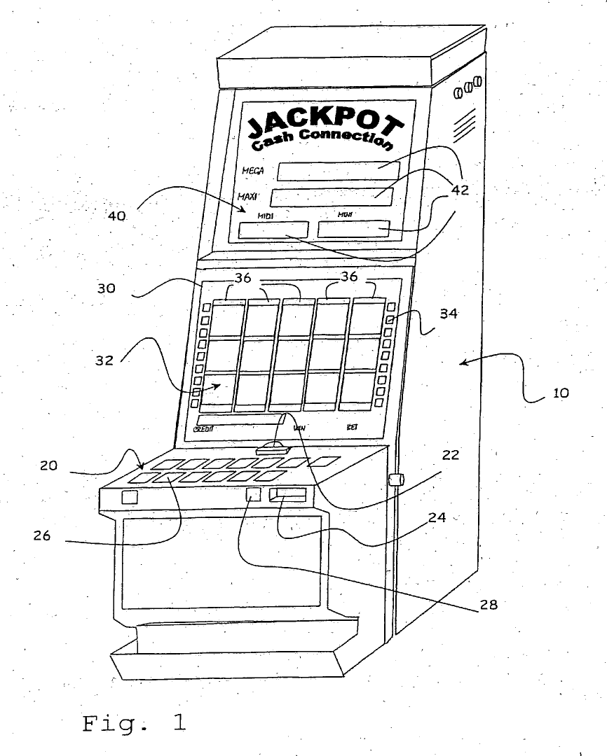

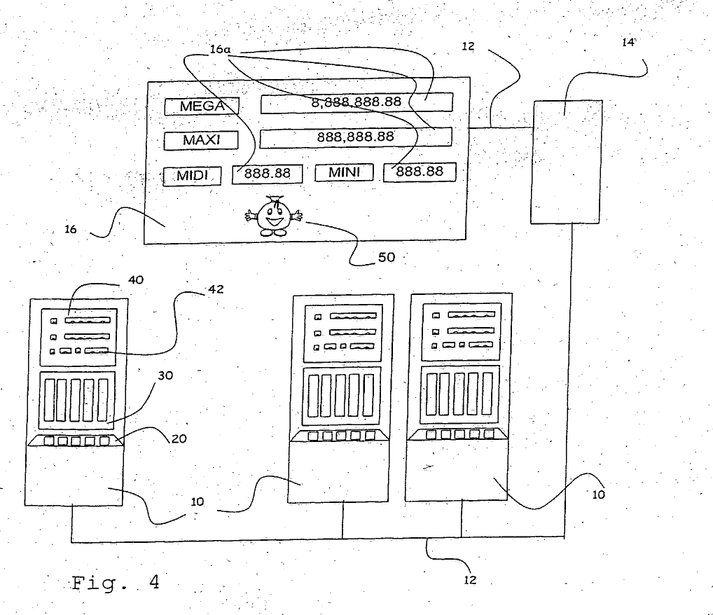

FIG. 1 shows a gaming console 10. The gaming console 10 has an operating panel 20 on which there is disposed a coin slot 22, a note slot 24, stake selectors 26, and a game initiator 28. The gaming console also has a display 30 that displays the outcome of the game. Display 30 shows the reels 36 (typically of a 3,4 or 5-reel machine) aligned to form at least one betting row. The reels 36 include a plurality of symbols 32. Line indicators 34 illuminate to display those lines on which the player has wagered a stake. A further display 40 shows the jackpot game title Cash Connection™ in the title, with the mega, maxi, midi, and mini payout displays, as shown in a central display in FIG. 4. The further display 40 has jackpots' sizes indicator 42.

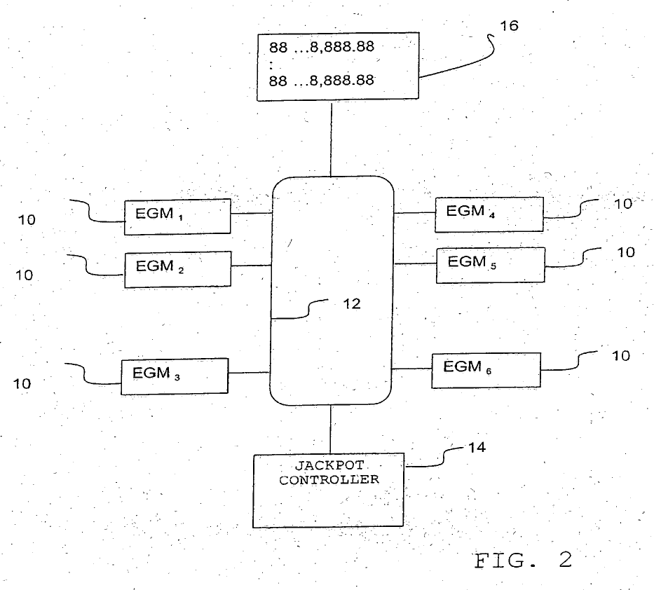

FIG. 2 shows a network 12 having a plurality of gaming consoles 10 connected thereto. The network also includes a jackpot controller 14 and at least on centralised display 16.

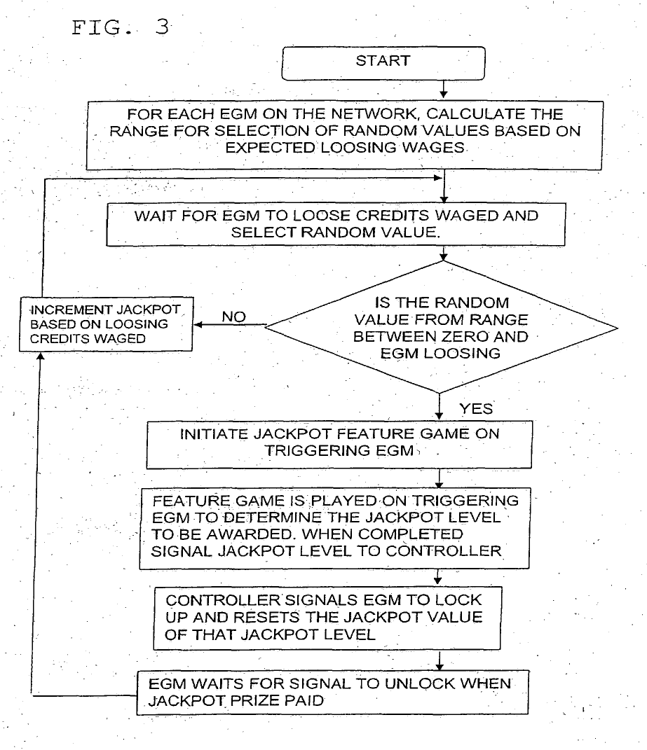

FIG. 3 shows a flowchart . . .

FIG. 4 shows a network 12 including a plurality of gaming consoles 10 connected thereto. A centralised display 16 shows the values 16a of four jackpots that may be won. An animated FIG. 50(or sprite (Kenny Cash™)) may be seen moving around the centralised display. There are the 4 Jackpots of differing values 16a that can be won, being the mega, maxi, midi, and mini. These values 16a match the corresponding values 42 displayed on the console 10.

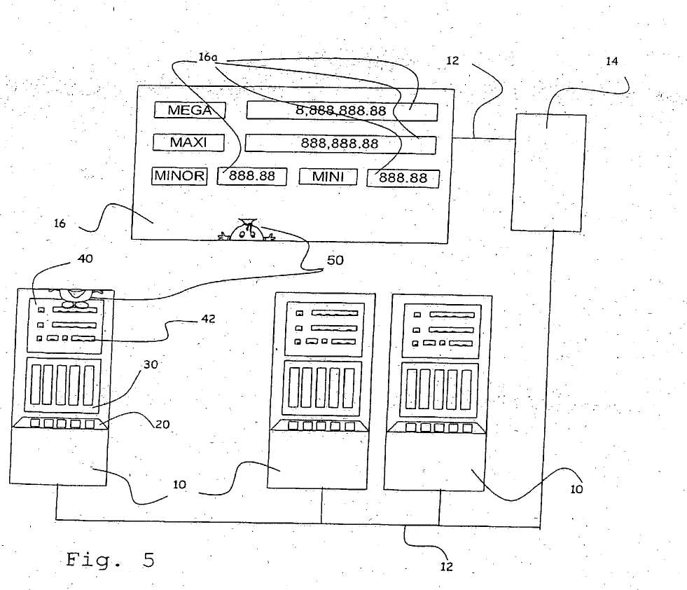

FIG. 5 shows a network 12 on which the animated FIG. 50 appears to move from the centralised display 16 to a further display 40 on a gaming console 10. The appearance of the sprite 50 on the further display 40 occurs when a trigger condition for the secondary game is satisfied (jackpot selector is activated), the sprite 50 will first move from the centralised display 16 to the further display 40 on a gaming console 10, of the gaming console 10 that triggers the secondary game (which will result in awarding a jackpot) and subsequently to the display 30 of the gaming console 10. While moving from the further display 40 to the display 30, the sprite 50 first exits the further display 40 and then appears on the display area 30 (so it is only on one display at any given time, not overlapping). It is within the scope of the present invention for the sprite 50 to appear on the centralised display 16, and be seen to move on to anyone of the displays 30 or 40 either directly or indirectly.

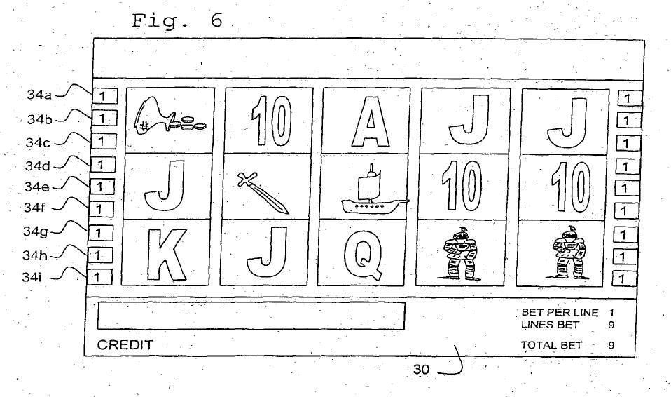

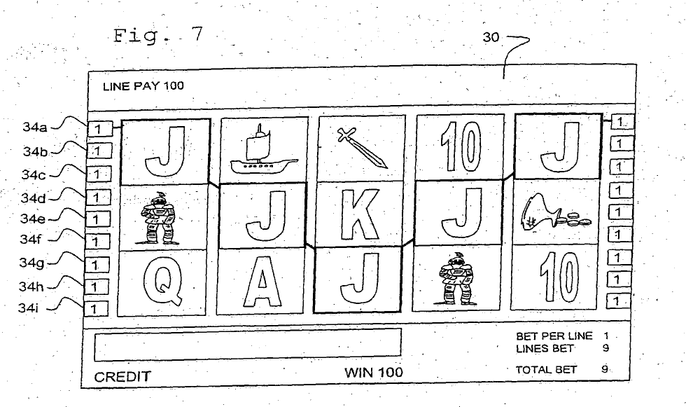

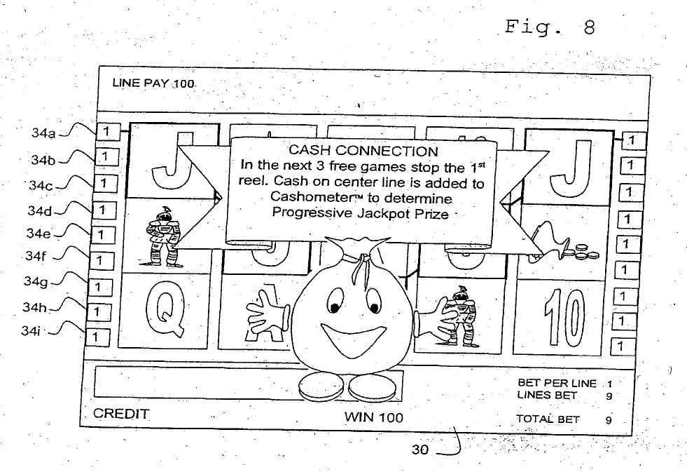

FIGS. 6, 7 and 8 show displays 30 in various conditions. The displays show a game where 9 pay lines (34a-34i) can be brought into play. FIG. 6 shows a display 30 where one credit was bet on each of the 9 lines (the line indicators 34 a to 34i display the bet wagered on each line) and no combination wins have been awarded, which provides for 9 possible chances to win the jackpot (if there have been more than one credit bet per line, there would have been more chances to win the Jackpot for each bought pay line). For example, if 2 credits per line were bet with 9 lines (34a-34i) wagered and with a result of a non winning game, then there would have been 18 chances to win the jackpot, 9×2=18). In FIG. 7, one credit was bet on each of the 9 lines (34a-34i) and a single line win 34a has been obtained, which in turn allows for 8 chances to win the Jackpot while the line with a winning combination 34a will not participate in the jackpot. The credits bet on non-winning lines are used to determine the trigger condition for the secondary game that awards one of the jackpots whose values 16a are shown on both the centralised display 16 and the further display 40. In one embodiment a random number is selected from a given range for each non-winning credits bet and it is matched against a given trigger number. Where at least one match exists, the trigger condition for the secondary game is satisfied. It should be understood that the said set of random numbers could contain any number of numbers but so that the number of elements of this set is proportional to the said non-winning credits bet. In an alternative embodiment for each of the said non winning credits bet a set of random number are selected from a given range and matched against a given trigger number for that set and should a given number of matches exist between the said sets and the said trigger numbers, the trigger condition for the secondary game is satisfied. Again it is to be understood that for each of the non winning credits bet the number of sets of random numbers selected and compared could be proportional to the said non winning credits bet rather than having a one to one correspondence. In a yet alternative embodiment a single random number may be selected from a range that is proportional to the non-winning credits bet and matched against a given trigger number. Thus there may be a number of ways random numbers are chosen in function of the non-winning credits bet and alternative ways of choosing random numbers as know in the art are not to be considered as departing from the spirit of this invention. Upon satisfying the trigger condition, if a centralised display 16 is included in the system, the sprite 50 that moves on this display would be seen moving to the gaming console's 10 further or secondary display 40 and in turn to gaming console's 10 gaming display 30. Alternatively a sprite 50 will appear (such as Kenny Cash™), and announce the trigger of the secondary game (as shown in FIG. 8).

In the alternative, if the chances of winning the jackpot game are based on the credits won as shown in FIG. 7, only the one credit bet that obtained a win would be used in determining the trigger condition in a similar fashion to the one described above, with winning credits replacing the non-winning credits bet.

In a yet other alternative, if the chance of winning the jackpot game is base, as described before, on some other event related to the outcome of the primary game, for example to the number of royal symbols displayed as the game outcome, with reference to FIG. 7, the number of 10, J, Q, K and A symbols, there would be 10 trigger chances used in determining the trigger condition, as there are ten royal symbols displayed in FIG. 7.

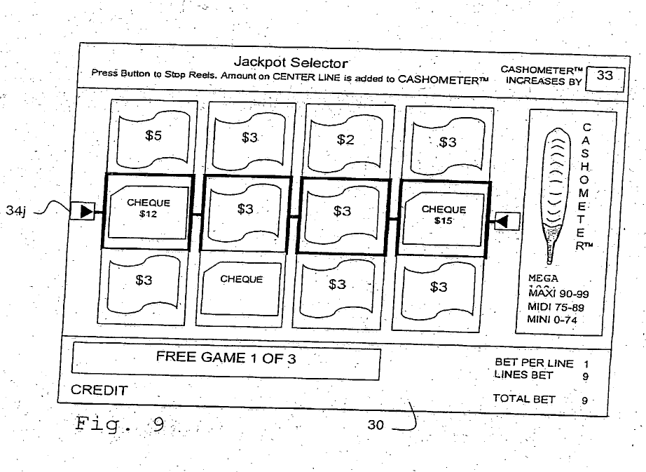

Once the trigger condition is met the game display would be controlled to display the secondary game as shown in FIG. 9. Depending on the outcome of the secondary game and on the score obtained one of the progressive jackpots would be awarded. The awarding of the jackpot may be celebrated by the display being controlled to display the sprite 10 animating in a fanciful manner and displaying a banner indicating the amount won.

FIG. 9 shows the Cash Connection™ Jackpot Selector (after trigger condition has been met). Upon playing the jackpot selector game (the secondary game) the reels spin, the player stops the first reel via one of the buttons of the Operating Panel 20 (or other means such as touch screen). The player aims to stop the symbol displayed 32 on the first reel 36 so that the highest possible denomination appears on the centre line 34j. The subsequent reels 36 will come to rest automatically. The numbers displayed on the central line are added (and increment the cashometer™). After 3 such games the total score obtained is compared to a score table to award one of the advertised jackpots.

The claims defining the invention are as follows:

1. A gaming console comprising a display, a game controller, a stake selector, and a game initiation means wherein on initiation by the game initiation means in a primary game the game controller selects a plurality of symbols and displays the selected symbols on said display and awards any prizes based upon the stakes wagered on winning combinations of the selected symbols, and awards a secondary prize in the event of a trigger condition wherein the probability of said trigger condition is proportional to a quantity determined by the result of the primary game wherein said quantity is one of the following:
a) the unpredictable quantity of the wager for which no prizes are awarded in the primary game;
b) the unpredictable number of losing combinations in the primary game on which wagers are made;
c) the unpredictable quantity of the stake wagered on winning combinations in the primary game;
d) the unpredictable number of winning combinations in the primary game on which wagers are made; or
e) the unpredictable amount of the prize awarded in the primary game.

2. A gaming console according to claim 1 wherein the display is selected from the group consisting of TFT screens, LCD screens, projection displays and video screens.

3. A gaming console according to either claim 1 or claim 2 wherein the game controller is selected from the group consisting of mechanical, electrical or electronic devices wherein said devices select a plurality of symbols and cause the selected symbols to be displayed on the display.

4. A gaming console according to any one of claims 1 to 3 wherein the stake selector is in the form of a physical or virtual button.

5. A gaming console according to any one of claims 1 to 4 wherein the game initiation means is in the form of a physical or virtual button.

6. A gaming console according to any one of claims 1 to 5 wherein the primary game is a spinning reels game.

7. A gaming console according to any one of claims 1 to 6 wherein the probability of said trigger condition is proportional to the unpredictable quantity of the wager for which no prizes are awarded in the primary game.

8. A gaming console according to any one of claims 1 to 6 wherein the probability of said trigger condition is proportional to the unpredictable number of losing combinations in the primary game on which wagers are made.

9. A gaming console according to any one of claims 1 to 6 wherein the probability of said trigger condition is proportional to the unpredictable quantity of the stake wagered on winning combinations in the primary game.

10. A gaming console according to any one of claims 1 to 6 wherein the probability of said trigger condition is proportional to the unpredictable number of winning combinations in the primary game on which wagers are made.

11. A gaming console according to any one of claims 1 to 6 wherein the probability of said trigger condition is proportional to the unpredictable amount of the prize awarded in the primary game.

12. A network comprising a multiplicity of gaming console wherein each of said multiplicity of gaming consoles comprises a display, a game controller, a stake selector, and a game initiation means wherein on initiation by the game initiation means in a primary game the game controller selects a plurality of symbols and displays the selected symbols on said display and awards any prizes based upon the stakes wagered on winning combinations of the selected symbols and wherein in a secondary game after the awarding of any prizes in the primary game the game controller awards a secondary prize in the event of a trigger condition wherein the probability of said trigger condition is proportional to a quantity determined by the result of the primary game wherein said quantity is one of the following:
a) the unpredictable quantity of the wager for which no prizes are awarded in the primary game;
b) the unpredictable number of losing combinations in the primary game on which wagers are made;
c) the unpredictable quantity of the stake wagered on winning combinations in the primary game;
d) the unpredictable number of winning combinations in the primary game on which wagers are made; or
e) the unpredictable amount of the prize awarded in the primary game.

13. A network according to claim 12 wherein the display is selected from the group consisting of TFT screens, LCD screens, projection displays and video screens.

14. A network according to either claim 12 or claim 13 wherein the game controller is selected from the group consisting of mechanical, electrical or electronic devices wherein said devices select a plurality of symbols and cause the selected symbols to be displayed on the display.

15. A network according to any one of claims 12 to 14 wherein the stake selector is in the form of a physical or virtual button.

16. A network according to any one of claims 12 to 15 wherein the game initiation means is in the form of a physical or virtual button.

17. A network according to any one of claims 12 to 16 wherein the primary game is a spinning reels game.

18. A network according to any one of claims 12 to 17 wherein the probability of said trigger condition is proportional to the unpredictable quantity of the stake wagered on winning combinations in the primary game.

19. A network according to any one of claims 12 to 17 wherein the probability of said trigger condition is proportional to the unpredictable number of losing combinations in the primary game on which wagers are made.

20. A network according to any one of claims 12 to 17 wherein the probability of said trigger condition is proportional to the unpredictable quantity of the stake wagered on winning combinations in the primary game.

21. A network according to any one of claims 12 to 17 wherein the probability of said trigger condition is proportional to the unpredictable number of winning combinations in the primary game on which wagers are made.

22. A network according to any one of claims 12 to 17 wherein the probability of said trigger condition is proportional to the unpredictable amount of the prize awarded in the primary game.

23. A network according to any one of claims 12 to 22 wherein the network includes a centralised display means on which the value of jackpot prize may be displayed and/or a jackpot character appears on the awarding of a jackpot prize were the jackpot prize is the said secondary prize.

24. A method of gaming comprising the steps of:
(i) in a primary game selecting a plurality of symbols and displaying the selected symbols on the display;
(ii) awarding any prizes based upon a stake wagered on winning combinations of the selected symbols;
(iii) determining a quantity based upon the result of the primary game; and
(iv) in a secondary game awarding a secondary prize in the event of a trigger condition wherein the probability of said trigger condition is proportional to the said quantity determined by the result of the primary game wherein said quantity is one of the following:
a) the unpredictable quantity of the wager for which no prizes are awarded in the primary game;
b) the unpredictable number of losing combinations in the primary game on which wagers are made;
c) the unpredictable quantity of the stake wagered on winning combinations in the primary game;
d) the unpredictable number of winning combinations in the primary game on which wagers are made; or
e) the unpredictable amount of the prize awarded in the primary game.

25. A method of gaming according to claim 24 wherein the probability of said trigger condition is proportional to the unpredictable quantity of the wager for which no prizes are awarded in the primary game.

26. A method of gaming according to claim 24 wherein the probability of said trigger condition is proportional to the unpredictable number of losing combinations in the primary game on which wagers are made.

27. A method of gaming according to claim 24 wherein the probability of said trigger condition is proportional to the unpredictable quantity of the stake wagered on winning combinations in the primary game.

28. A method of gaming according to claim 24 wherein the probability of said trigger condition is proportional to the unpredictable number of winning combinations in the primary game on which wagers are made.

29. A method of gaming according to claim 24 wherein the probability of said trigger condition is proportional to the unpredictable amount of the prize awarded in the primary game.

30. A method of gaming comprising a display, a game controller, a stake selector, and a game initiation means wherein on initiation by the game initiation means in a primary game the game controller selects a plurality of symbols and displays the selected symbols on said display and awards any prizes based upon the stakes wagered on winning combinations of the selected symbols, and wherein in a secondary game the game controller awards a secondary prize in the event of a trigger condition wherein the probability of said trigger condition is proportional to the outcome of an unpredictable event or result in the primary game other than a said combinations of selected symbols.
